(19) United States
(12) Patent Application Publication
(10) Pub. No.: US 2014/0113681 A1
(43) Pub. Date: Apr. 24, 2014

(54) PERSONAL COMMUNICATIONS DEVICE WITH CROSS ROUTER

(71) Applicants: Robert S. Reis, PALO ALTO, CA (US); Carl E. Berg, Atherton, CA (US)

(72) Inventors: Robert S. Reis, PALO ALTO, CA (US); Carl E. Berg, Atherton, CA (US)

(21) Appl. No.: 14/056,939

(22) Filed: Oct. 17, 2013

Related U.S. Application Data
(60) Provisional application No. 61/715,301, filed on Oct. 18, 2012.

(51) Int. Cl. H04W 88/06; H04W 72/04; H04B 7/185

(52) U.S. Cl. CPC H04W 88/06; H04B 7/18513; H04W 72/04
USPC 455/552.1

(57) ABSTRACT

A portable communications device (PCD) for communications over a plurality of communication channels and a cross router for controlling one or more of the communication channels to be active. Typically, the plurality of communications channels includes a cellular channel, a satellite channel and a WiFi channel.

### BACKGROUND OF THE INVENTION

This invention relates to mobile personal communications devices including cell phones, tablet computers, pads and other devices.

Mobile personal communications devices transmit and receive telephone calls and other communications using radio frequency (RF) signal channels that cover both small and large geographic areas. Mobile personal communications devices are moved around freely and are not required to stay in fixed locations.

Mobile communications devices support a wide variety of services such as voice, text messaging, multimedia, email, internet and numerous other and related applications including applications for storing and retrieving contact information, calendar information, music, photography, records and including many other business and personal applications.

The demand and need for personal communications devices is expanding at a rapid pace. There are many billions of devices in use around the world. There is an increasing need for devices that provide reliable one-way and two-way communications virtually anywhere on the earth even when any particular one or more channels for service are not available.

Communications services primarily have been provided in channels using wired connections in the Public Switched Telephone Network (PSTN), using wireless connections in cellular networks and using wireless connections in satellite networks.

Typically mobile personal communications devices connect in terrestrial networks having multiple cellular base stations (cell sites) and connect in space networks formed with constellations of orbiting satellites. Both cellular and satellite network channels are interconnected to the public switched telephone network (PSTN) channels to allow personal communications devices to be connected for communications anywhere in the world using both wired and wireless channels.

None of the existing network channels (PSTN, cellular or satellite) provides completely satisfactory communications. The wired PSTN devices are only available at fixed wired sites and are not mobile. The cellular network channels and the satellite network channels do not provide reliable services at all locations of the world under all conditions.

Cellular networks have communications enabled by short-range, base-stations. There are hundreds of thousands of cellular base-stations around the world serving many geographic regions. However, if there is no cell-site close enough to a cellular mobile device, cellular communications will not get through. Rural regions and other regions where adequate base station coverage has not been installed are without satisfactory cellular communications. Also, cellular communications in buildings is not always reliable due to the nature of the frequency used and the attenuation effects of the walls and ceilings of buildings. A large percentage of the area over the entire world is not covered by satisfactory cellular communications.

Satellite networks provide alternative communications to cellular, PSTN and other terrestrial communications channels. Various satellite constellations work together to provide coordinated ground coverage for wireless communications. Generally, satellite constellations are either Low Earth Orbiting satellites (LEDs) or geostationary satellites (GEOs).

Low Earth Orbiting satellites (LEDs) are often deployed with a substantial number of satellites in the constellation because the coverage area provided by a single LEO satellite is only a small area on the ground. The area on the ground covered by a single LEO satellite moves as the LEO satellite travels at a high angular velocity. A high angular velocity is needed in order to maintain the LEO satellite in orbit. Many LEO satellites are needed to maintain continuous coverage over regions on the earth.

Geostationary satellites (GEOs) are generally deployed with a lower number of satellites than LEO satellites since a single GEO satellite, moving at the same angular velocity as the rotation of the Earth's surface, provides permanent coverage over a large region on earth.

In regions where cellular communications are not adequate, satellite communications may be suitable as an alternative. However, satellite communications in buildings, vehicles and ships is not always reliable due to the nature of the frequency used and the attenuation effects of walls and ceilings.

In buildings, vehicles and other locations where cellular or satellite communications are not satisfactory, Wi-Fi communications, Blue Tooth and other local communications can be alternatives to or adjuncts to cellular and satellite wireless communications.

In general, users of mobile personal communications devices want communications to get through irrespective of the communications channels that are used. The user is generally not interested in the channels used for a communication as long as the communication is completed. Unfortunately, guaranteed completion of communications is not always the case.

Often an attempted telephone call or message using cellular communications will not be completed or will be interrupted due to poor signal quality at the sending user's location or at the receiving user's location. Under some circumstances, a user sending a text message or other message from a wireless device does not know in a timely way if the communication has been completed. For example, when a text (SMS) message or a voice message is sent, the sending user is sometimes provided an acknowledgement. The sending user may mistakenly assume that this acknowledgement means the message was (in fact) displayed or received at the recipient user's device (cell phone). This assumption is often not the case. The acknowledgement only indicates that the SMS or voice server mailbox has received the message and not that the intended user's device has received the message. If the intended user's device was OFF or out of cell range when sent, the server may eventually deliver the message to the user's device when the user's device is powered back ON and is in cell phone range. When delivery of the message actually happens, the result is accompanied by a delivery confirmation.

Although communications systems for mobile devices provide acceptable communications under certain conditions, none of the systems are fully adequate to meet user's needs and expectations.

In consideration of the above background, there is a need for improved personal communications devices that can communicate from most all locations of the world and function even when some communications channels fail or are otherwise not available.

### SUMMARY

The present invention is a portable communications device (PCD) for communications with two or more communications systems. The portable communications device includes a power unit for powering the portable communications device, a user interface for interfacing with a user, a plurality of communication channels for carrying communications by the communications device, a cross router for controlling one or more of the communication channels to be active for carrying communications for the portable communications device and a control unit for controlling the portable communications device using the active one or more active communication channels. Typically, the plurality of communication channels includes a cellular communication channel and a satellite communication channel.

The cross router includes a protocol unit for storing the protocol for each of the communication channels, a channel state unit for detecting the availability of each of the communication channels for communications with the portable communications device, a channel logic unit for analyzing the available ones of the communication channels and setting the active and inactive state of the communication channels, a channel command unit for issuing commands for each of the active one or more communication channels according to the protocols in the protocol unit.

The cross router manages the gateway operations including the send/receive protocols and various acknowledgements for cellular, satellite and other channels. In an example of an SMS text, if the SMS message does not get delivered all the way to the screen of the recipient user though one channel such as cellular, the message is delivered through an alternative channel such as satellite with sequential attempts. Alternatively, the message can be broadcast in parallel broadcasts over multiple active channels.

The cross router functions as a communications manager. In the SMS message example, the cross router senses whether or not a delivery confirmation has occurred. For times when a delivery confirmation does not occur in a reasonable time or for times when a delivery confirmation is not available as part of the protocol, one or more other appropriate communications channels are selected and used instead.

There can be many communications paths and channels that can be used. In one example, the primary path to get a message through to a recipient user is via SMS [short message service] using a cellular channel. Another way to get a message through to someone is via email. Another way to get through to someone is satellite messaging using a satellite channel. Still another way to get through to a recipient user is text-to-speech over land-lines (using the PSTN network channel). Still other paths can be used as they become available. The cross router operates to select the paths and channels whenever more than one communications route is available.

This process of alternative communications via cross routing makes a process that is not always reliable and converts it to a process which is extremely reliable. There are very few places in the world in which the personal communications device will not have a potential connection to one of cellular, WiFi, satellite and land-line communications channels.

The cross router has value as long as there is more than one choice for getting a message through. The presence of more than one path is almost always the case, for example, cell phones almost always have texting and voice. When cross router is on hardware that has more choices (e.g., satellite, text to spec, WiFi and other), the communications become even more robust.

The foregoing and other objects, features and advantages of the invention will be apparent from the following detailed description in conjunction with the drawings.

### BRIEF DESCRIPTION OF THE DRAWINGS

FIG. 1 depicts a schematic representation of a personal communications device.

FIG. 2 depicts a schematic representation of the personal communications device of FIG. 1 including a cross router connecting a smart phone and a satellite device.

FIG. 3 depicts a schematic representation of a personal communications device of the FIG. 1 type deployed within communications range of close communications channels, terrestrial cellular channels, and satellite channels.

FIG. 4 depicts a schematic representation of a top view of one embodiment of the personal communications device of FIG. 1.

FIG. 5 depicts a schematic representation of an end view of the personal communications device of FIG. 4.

FIG. 6 depicts a schematic representation of personal communications device of FIG. 4 where the smart phone and a satellite device are nested together with the antenna flap open.

FIG. 7 depicts a schematic representation of an end view of the personal communications device of FIG. 6.

FIG. 8 depicts a schematic representation of personal communications device of FIG. 6 where the smart phone and a satellite device are nested together with the antenna flap closed.

FIG. 9 depicts a schematic representation of an end view of the personal communications device of FIG. 8.

FIG. 10 depicts a schematic representation of an end view of the personal communications device of FIG. 7 depicting by dotted lines the antenna rotated at different angles.

FIG. 11 depicts a schematic representation of a personal communications device formed as a combination of a smart phone and a satellite device.

FIG. 12 depicts a schematic block diagram representation of further details of the personal communications device of FIG. 11.

FIG. 13 depicts a schematic representation of another embodiment of the satellite device for use in the personal communications devices of the FIG. 12.

FIG. 14 depicts a schematic representation of another embodiment of a personal communications device of FIG. 1 where the local RF unit and the satellite RF unit are under common control in the same device.

FIG. 15 depicts a schematic representation of personal communications devices of the FIG. 1 type deployed within communications range of multiple communications systems including terrestrial local communications systems, airborne systems and multiple satellite communications systems.

FIG. 16 depicts a detailed block diagram of a conventional smartphone.

### DETAILED DESCRIPTION

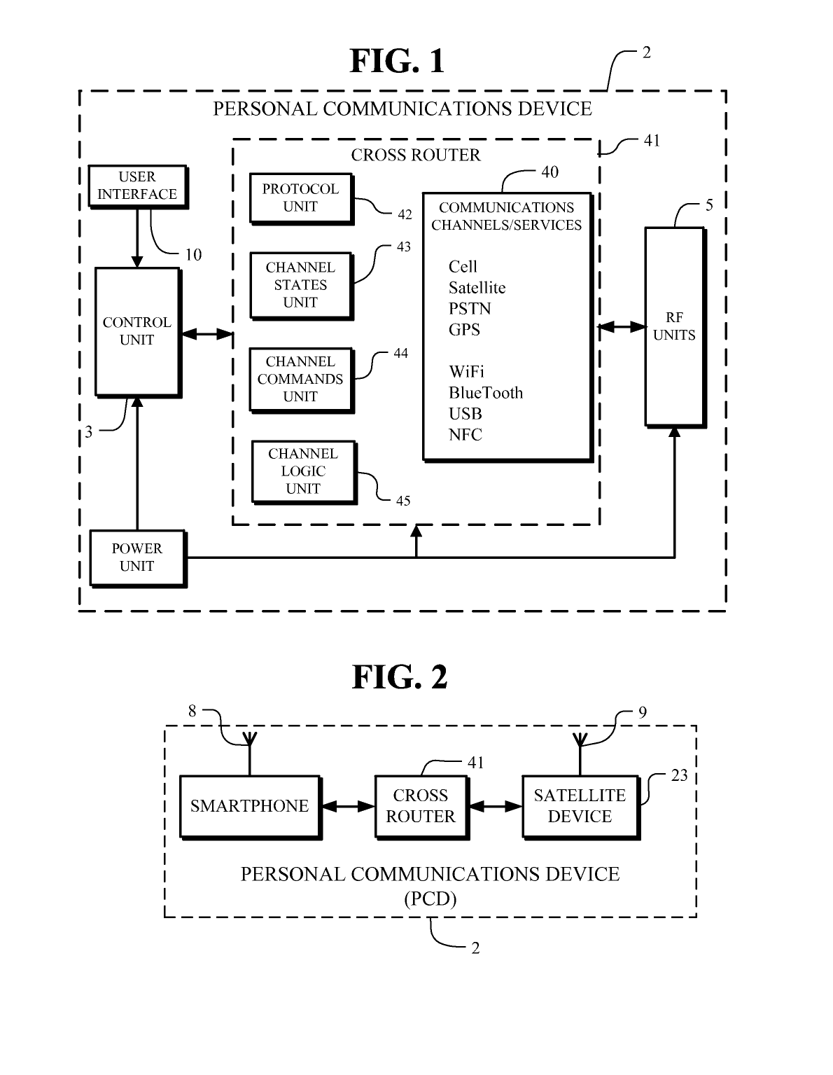

In FIG. 1, a schematic representation of a personal communications device 2 is shown including a control unit 3, a power unit 4, a cross router 41 and RF units 5. The control unit 3 controls the communications of the personal communications device 2 and has the capacity to execute many different algorithms both hidden from user control and/or under user control. The power unit 4 includes one or more batteries to enable the personal communications device 2 to be portable. The personal communications device 2 includes components for communications over multiple communication channels in multiple communications systems. The multiple communications systems include close communications systems, cellular communication systems and satellite communications systems. Typical close communications systems are WiFi, BlueTooth, NFC, VoIP wireless systems.

In FIG. 1, the cross router 41 includes a protocol unit 42 for storing the protocol for each of the communication channels, a channel state unit 43 for detecting the availability of each of the communication channels for communications with the portable communications device, a channel command unit 44 for issuing commands for each of the active one or more communication channels according to the protocols in the protocol unit and a channel logic unit 45 for analyzing the available ones of the communication channels and controlling the active and inactive states of the communication channels and services 40.

For local communications, the personal communications device 2 typically includes all the features of a smartphone and is thereby able to communicate in local environments using a cellular communications system. Examples of such smartphones are Apple's i-phone using the Apple operating system and Samsung's Galaxy using the Android operating system. Many other smartphones are available or are becoming available using the Apple, Android or other operating systems.

In one hiker example of operation, a sending user desires to send an SMS message to a receiving user who is a hiker on a mountain. The sender does not know whether the hiker is in cellular range or not. The sending user's initial attempt is to communicate by SMS. The cross router 41 checks to confirm that a text channel is available as indicated by the channel states unit 43 and issues commands under control of the channel commands unit 44 according to the SMS protocol established by the protocol unit 42 and thereby send the SMS message. Within a short period of time, the channel logic determines that no delivery message is received, even if an acknowledgment is received, indicating that there is no confirmation that the message was delivered to the hiker's handset. The cross router 41 operates to send the same message via one or more available alternative communications channels. The cross router 41 checks to confirm what other channels are available as indicated in the channel states unit 43. From the available channels, the cross router 41 selects one or more channels, such as e-mail and satellite, and issues commands under control of the channel commands unit 44 according to the email and satellite message protocols established by the protocol unit 42 and thereby sends the e-mail and satellite messages.

In the hiker example, the personal communications device 2 of the hiker on a mountain recognizes that the hiker's device is out of range of cellular towers in a cellular system. The cross router 41 in the hiker's personal communications device 2 turns off the cellular RF and makes the state of the satellite message receiver active in the channel states unit 43. The cross router 41 causes commands to be issued by the commands unit 44, according to the satellite messaging protocol stored in protocol unit 42, to poll the Satellite Message Gateway of an orbiting satellite to learn if there are messages targeted for the hiker's personal communications device 2. The Satellite Message Gateway responds and the cross router 41 in the hiker's personal communications device 2 causes the message to be received from the satellite. The message is delivered to the hiker over the user interface 10 of the hiker's personal communications device 2.

In a person at home example, the at-home user's cross router 41 recognizes that there is limited cellular communications available. The at-home user's cross router 41 makes the WiFi channel active in the channel states unit 43 of the at-home user's personal communications device 2.

In the at-home user example, a sending user sends an SMS message targeted for the at-home user using the cellular system but the SMS message does not get through to the at-home user. The sending user's personal communications device 2 having a cross router 41 detecting or suspecting that the SMS message did not get through sends an e-mail equivalent of the SMS message shortly after the SMS message was sent and the e-mail message equivalent is quickly delivered to the at-home user's personal communications device 2.

In a helpless person example, a person is at home and falls down and cannot get up. The helpless person desires to send an urgent help message requesting assistance. However, the primary communications path via the cell phone in that part of the home is not strong. The cross router 41 in the helpless person's personal communications device 2 recognizes that the state of cellular channel in the channel states unit 42 is inactive and therefore sends the help message on one or more active channels which are, for example, e-mail, satellite and landline.

In an injured person example, a person is fishing, stumbles and breaks his leg. The injured person is in need of assistance. A mayday button or code is touched on personal communications device 2 which commands the cross router 41 to use all active channels of communications at once.

In a voice message example, a calling user is attempting to place a voice call at a home or at an office with a weak cellular signal. The cross router 41 determines that the cellular voice channel has an inactive setting in the channel states unit 43. The cross router 41 checks to confirm that a WiFi channel is available as indicated by the channel states unit 43 and issues commands under control of the channel commands unit 44 according to the VoIP protocol established by the protocol unit 42 and thereby send the VoIP message. In one embodiment, the cross router 41 selects a VoIP service such as Skype to complete the voice communication.

The communications channels and services 40 include for example, cellular, satellite, PSTN, global positioning service (GPS), WiFi, BlueTooth, USB and NFC. In addition and in some embodiments, the personal communications device 2 includes communications systems for emergency, search and rescue as listed in the following TABLE 1.

TABLE 1

| Frequency (MHz.) | Name | Utility | Modulation |
|---|---|---|---|
| 121.5 | CAP | Civil Air Patrol | AM |
| 156.8 | Ch 16 | Marine | FM |
| 155.16 | | Mountain Rescue | FM |
| 154.28 | | Fire | FM |
| 155.475 | | Police | FM |

The RF unit 5 of personal communications device 2 includes components for satellite communications systems. Some of the satellite communications systems suitable for communications with the personal communications device 2 listed in the following TABLE 2:

TABLE 2

| Name | Provider | Number Satellites |
|---|---|---|
| LEO | Cospas-Sarsat | |
| LEO | Iridium | |
| LEO | Globalstar | |
| LEO | Orbcomm | |
| GEO | Inmarsat | |

In FIG. 2, a schematic representation of a personal communications device 2 formed as a combination of a smartphone 22 and a satellite device 23 is shown. The combination of the smartphone 22 and the satellite device 23 inherently includes the control unit 3, the power unit 4 and the RF unit 5 as described in connection with FIG. 1. These units 3, 4 and 5 can be either distributed or integrated. In a fully distributed embodiment, the smartphone 22 is essentially a standalone device like Apple's i-phone, Samsung's Galaxy or other readily available smartphones. These smartphones operate in widely available cellular systems. In the fully distributed embodiment, the satellite device 23 is an add-on to the smartphone 22, using where possible, components and operations of the smartphone 22 while providing the additional components and operations necessary for satellite communications. Among other things, the additional components for satellite operation include an antenna 9 and transceiver circuits suitable for satellite communications. The control unit 3 and power unit 4 components of the smartphone 22 can be shared, or shared in part, with the satellite device 23.

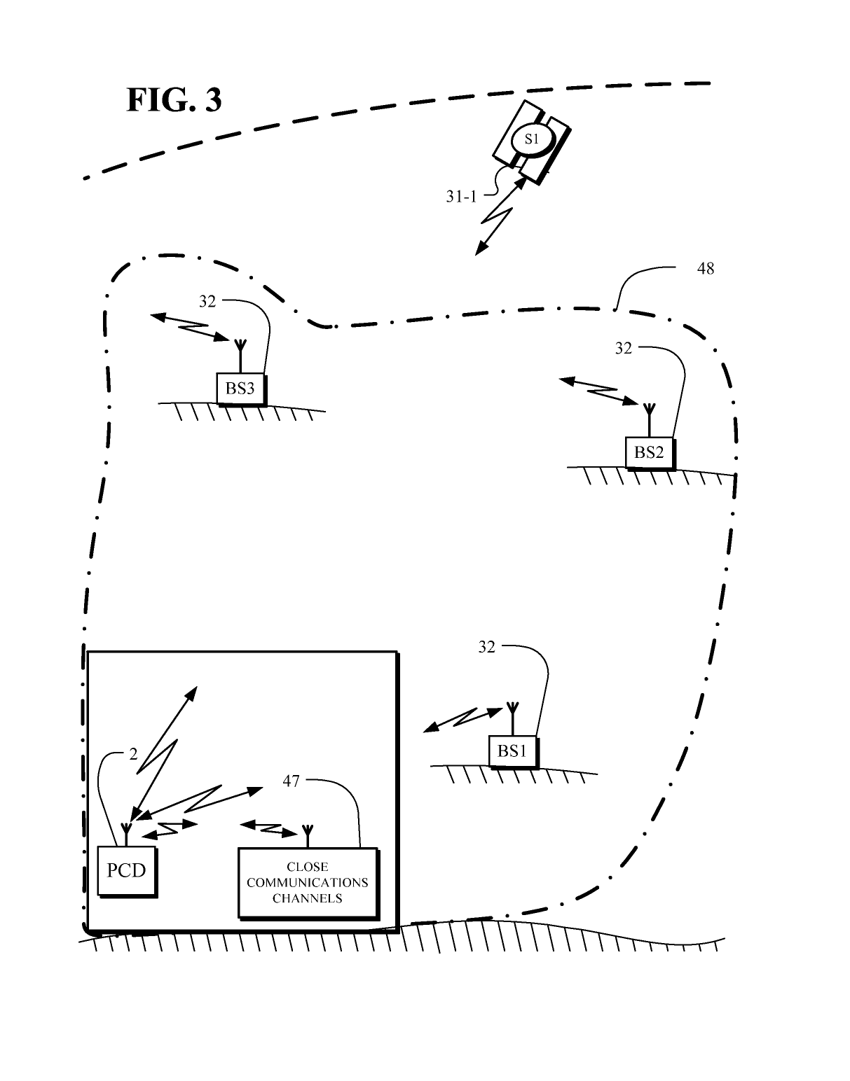

In FIG. 3, a schematic representation of a personal communications device 2 of the FIG. 1 type deployed within communications ranges of terrestrial close communications systems 47, cellular communications systems 32 and satellite communications systems including satellite 31-1 is shown. The satellite 31-1 is typically part of a satellite constellation. Such satellites in a constellation have shared controls to provide coordinated ground coverage for satellite communications with the personal communications device 2 and other ground based devices. The satellites in a communications system include earth orbiting satellites (LEO) or geosynchronous satellites (GEO) such as those identified in the foregoing TABLE 2.

In FIG. 3, the personal communications device 2 communicates with the close communications channels 47 and the cellular communications system 32 and/or any of the emergency, search and rescue communications systems of TABLE 1. The cellular communications system 32 includes the base stations BS1, BS2 and BS3 which cover the cellular region 48.

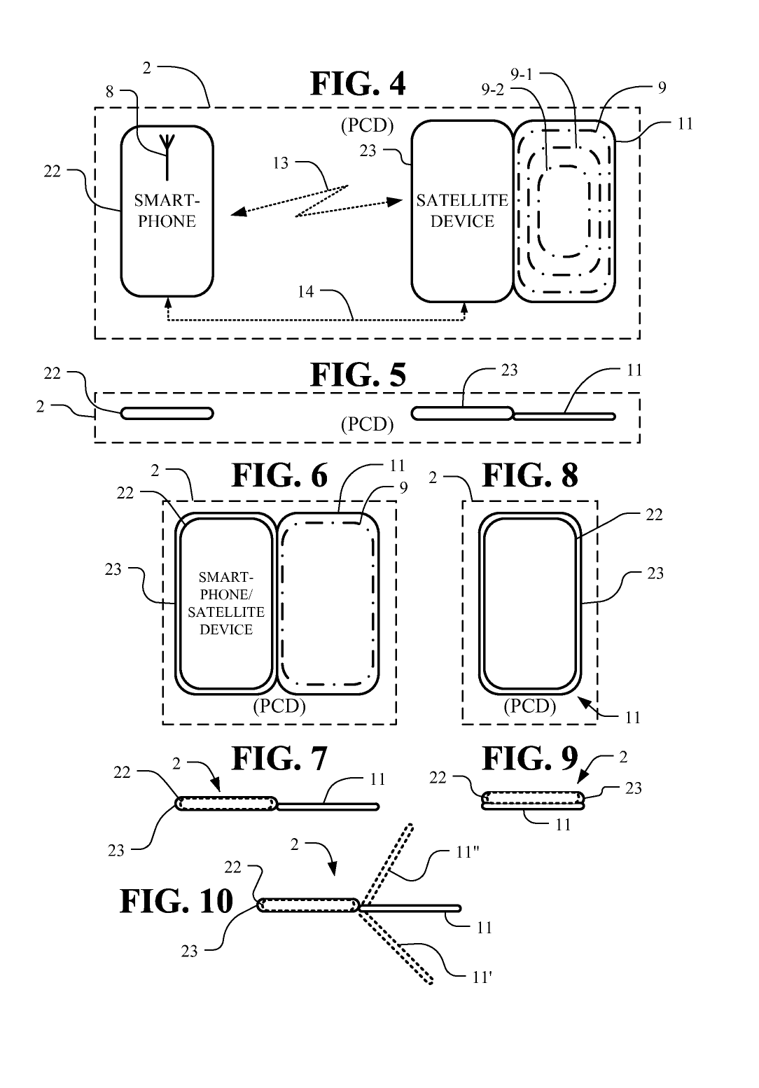

In FIG. 4, a schematic representation of a top view of one embodiment of the personal communications device 2 of FIG. 1 is shown. In FIG. 4, the approximate sizes of the smartphone 22 and the satellite device 23 of FIG. 2 are shown. In FIG. 4, the personal communications device 2 is a fully distributed embodiment where the smartphone 22 is essentially a standalone device like Apple's i-phone, Samsung's Galaxy or other readily available smartphones. In this fully distributed embodiment, the smartphone 22 communicates with the satellite device 23 with an RF link 13 (such as Bluetooth, WiFi or other) through the Bluetooth, WiFi or other facilities of the smartphone 22 and satellite device 23 or by a direct wire connection 14 through the wire plug connections of the smartphone 22 and satellite device 23. The satellite device 23 includes an area, such as flap 11, that contains the satellite antenna 9. The flap 11 in some embodiments includes multiple antennas 9, 9-1, 9-2 and so on having sizes and properties suitable for different ones of the satellite frequencies of satellite communications systems.

In FIG. 5, a schematic representation of an end view of the personal communications device 2 of FIG. 4 is shown. The smartphone 22 and the satellite device 23 are represented for purposes of illustration as separated by a distance. The distance in actuality may be of any amount from nothing to numbers of meters depending upon the embodiment selected. The distance, however, cannot exceed the communication range of the RF connection 13 or the wired connection 14.

In FIG. 6, a schematic representation of personal communications device 2 of FIG. 4 is shown where the smartphone 22 and the satellite device 23 are superimposed and nested together without any separation. The flap 11 holding the satellite antenna 9 is shown in the fully open position.

In FIG. 7, a schematic representation of an end view of the personal communications device 2 of FIG. 6 is shown where the smartphone 22 and the satellite device 23 are super-imposed and nested together without any separation. The flap 11 is shown in the fully open position.

In FIG. 8, a schematic representation of personal communications device 2 of FIG. 6 is shown where the smart phone 22 and the satellite device 23are nested together with the antenna flap 11 closed and under the superimposed smart phone 22 and satellite device 23.

In FIG. 9, a schematic representation of an end view of the personal communications device 2 of FIG. 8 is shown. The smart phone 22 and the satellite device 23 are nested together with the antenna flap 11 closed and under the superimposed smart phone 22 and satellite device 23.

In FIG. 10, a schematic representation of an end view of the personal communications device 2 of FIG. 6 is shown. The flap 11 is in a fully open position and can be rotated as depicted by dotted lines. The flap 11 is rotated in one direction to the position shown as 11′ and is rotated in the opposite direction to the position shown as 11″. The rotation of the flap 11 and therefore the antenna 9 assists in the good communication between the personal communications device 2 and a satellite 31.

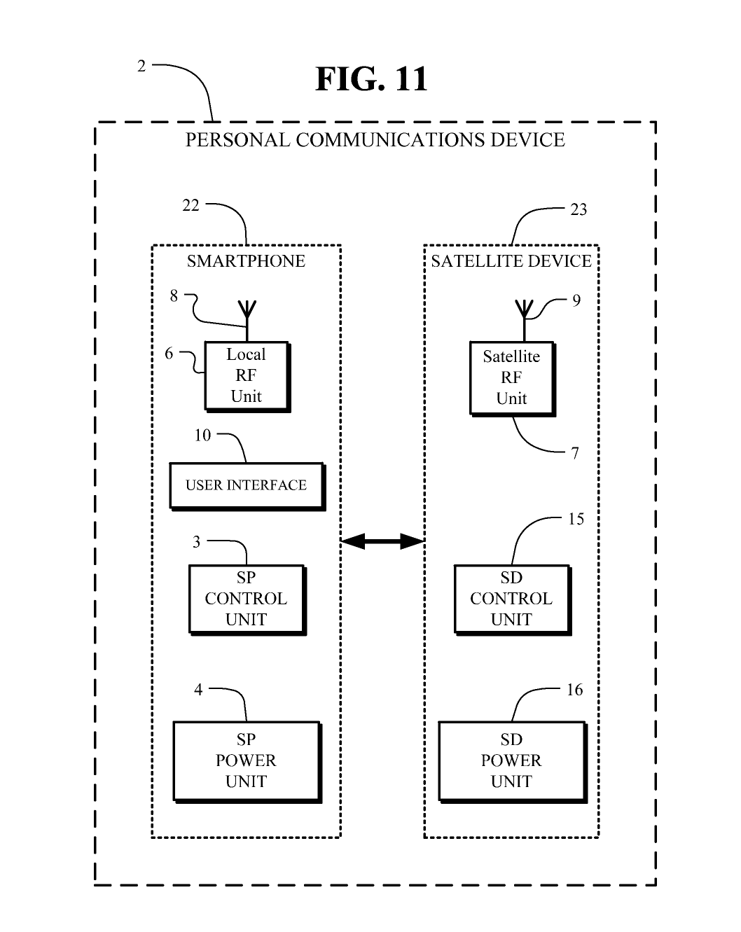

In FIG. 11, a schematic representation of a personal communications device 2 formed as a combination of a smart phone 22 and a satellite device 23 is shown. The smartphone 22 includes a local RF unit 6, a user interface 10, a SP control unit 3 and an SP power unit 4. The local RF unit 6 operates to communicate with local communication systems such as cellular systems. The user interface 10 operates with inputs from and outputs to a user. For example, the inputs include keypad and audio inputs and the outputs include display and audio outputs. The SP control unit 3 includes a processor, storage and related devices for controlling operations of the smartphone 22 and the personal communications device 2. The SP control unit 3 executes code including algorithms useful or necessary for control operations. The SP power unit 4 includes a battery and other components for powering the smartphone 22 and the personal communications device 2.

The satellite device 23 includes a satellite RF unit 7, a SD control unit 15 and an SD power unit 15. The satellite RF unit 7 operates to communicate with satellite communication systems such as LEO and GEO systems. The satellite device 23 operates for user interface operations under control of the user interface 10 of smartphone 22. In alternate embodiments, satellite device 23 can include a user interface. The SD control unit 15 includes a processor, storage and related devices for controlling operations of the satellite device 23 and the personal communications device 2. The SD control unit 15 executes code including algorithms useful or necessary for control operations. The SD power unit 16 includes a battery and other components for powering the satellite device 23 and the personal communications device 2.

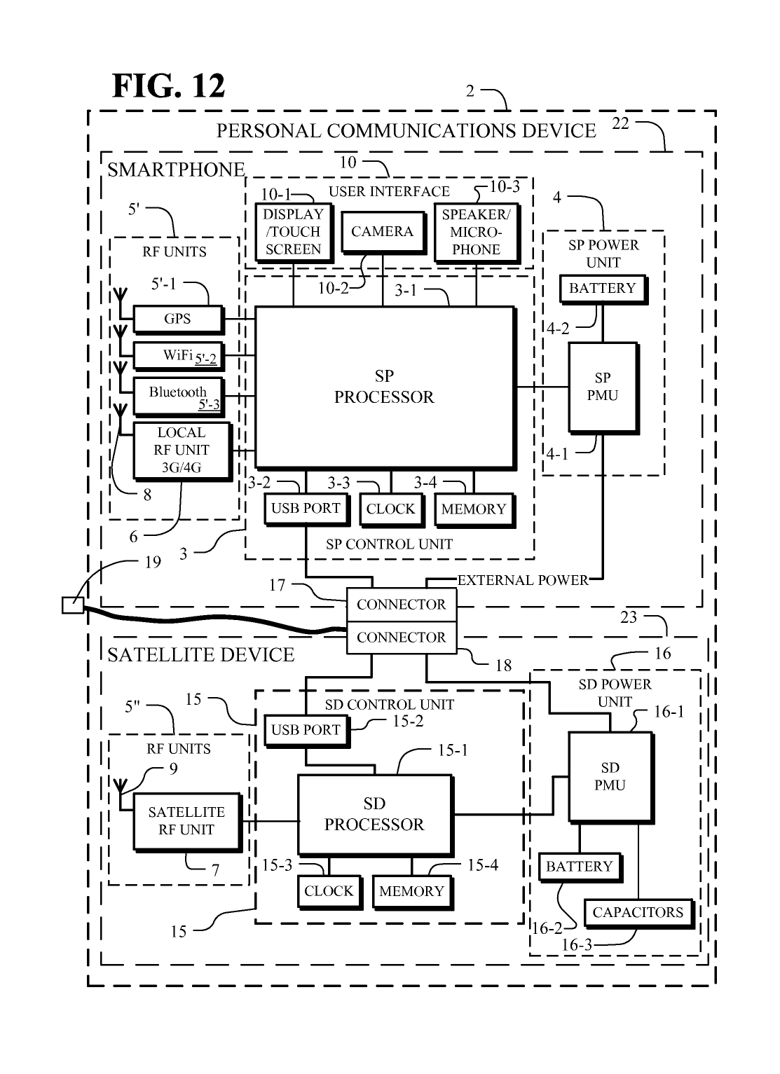

In FIG. 12, a schematic block diagram representation of further details of the FIG. 11 personal communications device 2 is shown.

In FIG. 12, the smartphone 22 includes RF units 5′, a user interface 10, a SP control unit 3 and an SP power unit 4. The RF units 5′ includes a GPS unit 5′-1, a WiFi unit 5′-2, a Bluetooth unit 5′-3 and a local RF unit 6. The local RF unit 6 operates to communicate with local communication systems such as cellular systems. The user interface 10 includes a display/touch screen 10-1, a camera 10-2 and a speaker/microphone 10-3 and operates with inputs from and outputs to a user. For example, the inputs include keypad and audio inputs and the outputs include display and audio outputs. The SP control unit 3 includes a processor, storage and related devices for controlling operations of the smartphone 22 and the personal communications device 2. The SP control unit 3 executes code including algorithms useful or necessary for control operations. The SP power unit 4 includes a power management unit 4-1 and a battery 4-2 for powering the smartphone 22 and the personal communications device 2.

In FIG. 12, satellite device 23 includes RF units 5″, an SD control unit 15 and an SD power unit 16. The RF units 5″ include at least a satellite RF unit 7. The satellite RF unit 7 operates to communicate with satellite communication systems such as LEO and GEO systems. The SD control unit 15 includes a processor 15-1, a USB port 15-2, a clock 15-3 and storage including memory 15-4. The SD control unit 15 operates to control operations of the satellite device 23 and the personal communications device 2. The SD control unit 15 executes code, stored in memory 15-4, for performing algorithms useful or necessary for control operations. The SD power unit 16 includes an SD power management unit (PMU) 16-1, a battery 16-2 and super capacitors 16-3 for powering the satellite device 23 and the personal communications device 2. The satellite device 23 connects through connector 18 to the connector 17 of the smartphone 22. In one embodiment, the connector 18 is connected to a terminal 19 which provides the ability to recharge the battery 16-2 and capacitors 16-3 in the satellite device 23 and the battery 4 in the smartphone 22.

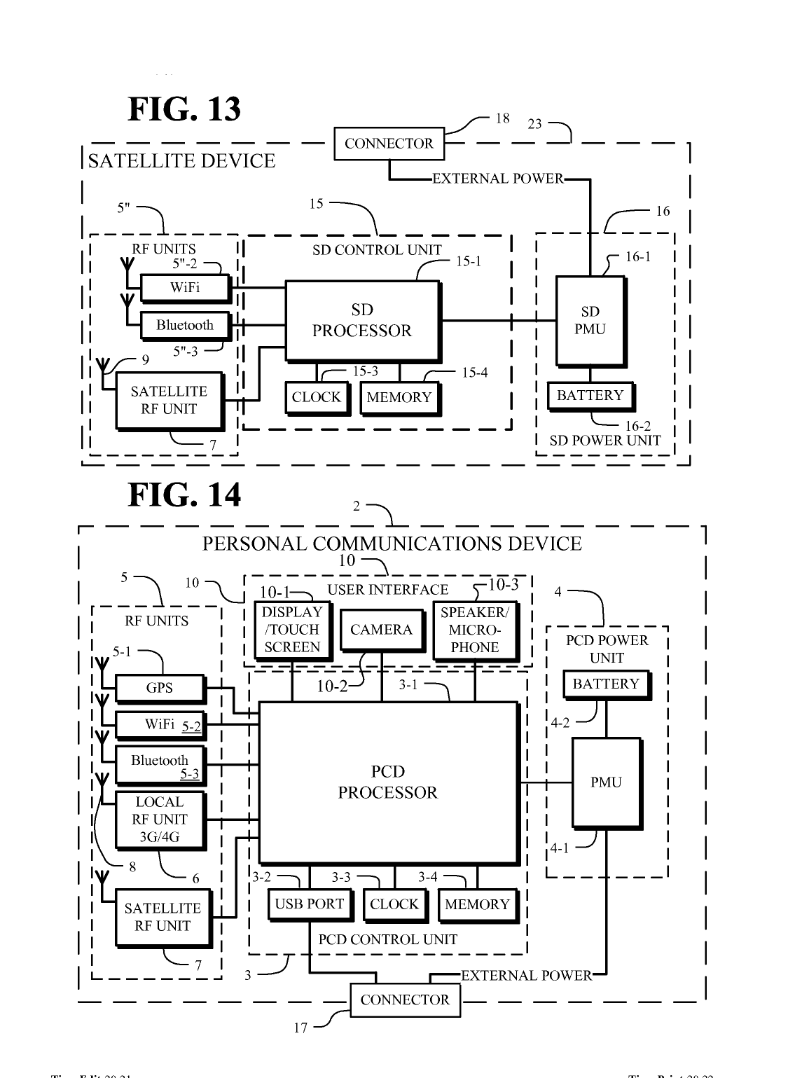

In FIG. 13, a schematic representation is shown of another embodiment of a satellite device 23 for use in the personal communications device 2 of FIG. 12. The satellite device 23 includes RF units 5″, an SD control unitl5 and an SD power unit 16. The RF units 5″ include a WiFi unit 5″-2, a Bluetooth unit 5″-3 and a satellite RF unit 7. The satellite RF unit 7 operates to communicate with satellite communication systems such as LEO and GEO systems. The WiFi unit 5″-2 and a Bluetooth unit 5″-3 are available for communicating with the WiFi unit 5′-2 and Bluetooth unit 5′-3 of the smartphone 22 of FIG. 12. The interaction between the smartphone 22 and the satellite device 23 is controlled by the Bluetooth and/or WiFi RF connections. The SD control unit 15 includes a processor 15-1, a clock 15-3 and storage including memory 15-4. The SD control unit 15 operates to control operations of the satellite device 23 and the personal communications device 2. The SD control unit 15 executes code, including algorithms useful or necessary for control operations, stored in memory 15-4. The SD power unit 16 includes an SD power management unit (PMU) 16-1 and a battery 16-2 for powering the satellite device 23 and the personal communications device 2.

In FIG. 14, a schematic representation is shown of another embodiment of a personal communications device 2 of FIG. 1 where the local RF unit 6 and the satellite RF unit 7 are under common control of the PCD control unit 3. In FIG. 14, the personal communications device 2 includes RF units 5, a user interface 10, a PCD control unit 3 and an PCD power unit 4. The RF units 5 include a GPS unit 5-1, a WiFi unit 5-2, a Bluetooth unit 5-3 and a local RF unit 6. The local RF unit 6 operates to communicate with local communication systems such as cellular systems. The user interface 10 includes a display/touch screen 10-1, a camera 10-2 and a speaker/microphone 10-3 and operates with inputs from and outputs to a user. For example, the inputs include keypad and audio inputs and the outputs include display and audio outputs. The PCD control unit 3 includes a processor, storage and related devices for controlling operations of the personal communications device 2. The PCD control unit 3 executes code including algorithms useful or necessary for control operations. The PCD power unit 4 includes a power management unit 4-1 and a battery 4-2 for powering the smartphone 22 and the personal communications device 2.

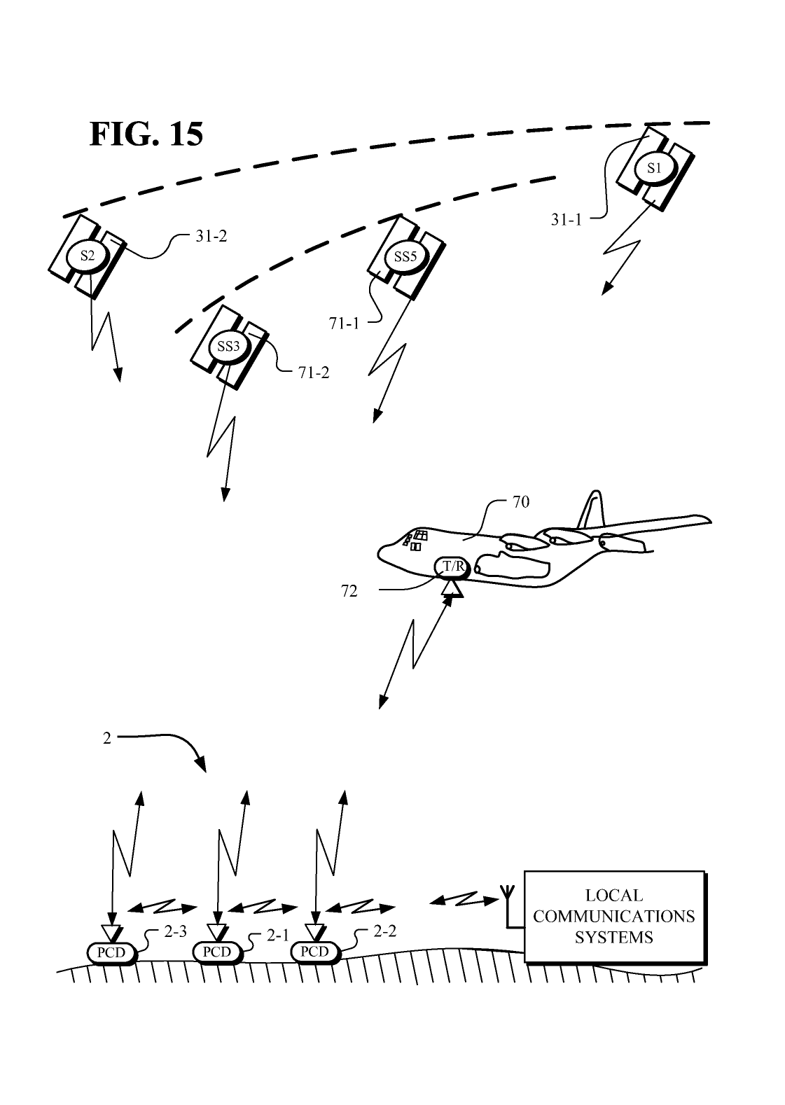

In FIG. 15, a schematic representation is shown of personal communications devices 2 of the FIG. 1 type deployed within communications range of multiple communications systems. The communications systems of FIG. 15 include local communications systems 80. In one embodiment, the local communications systems 80 is a cellular system. In the cellular system, the personal communications devices 2, including devices 2-1, 2-2 and 2-3, communicate in small geographic areas called cells. Each cell covers a small geographic area and collectively an array of adjacent cells covers a larger geographic region. The local communications systems 80 includes Base Station (BS) which handle all the cellular calls for the personal communications devices 2.

The communications systems of FIG. 15 in some embodiments includes local communications systems for emergency, search and rescue such as Civil Air Patrol, Marine, Mountain Rescue, Fire and Police. The air patrol communicates from an aircraft 70 having a local RF transceiver 70. The communications systems of FIG. 15 in some embodiments includes one or more satellite communications systems. For example, the GEO satellites 31-1 and 31-2 are in a GEO orbit and the LEO satellites 71-1 and 71-2 are in a LEO orbit.

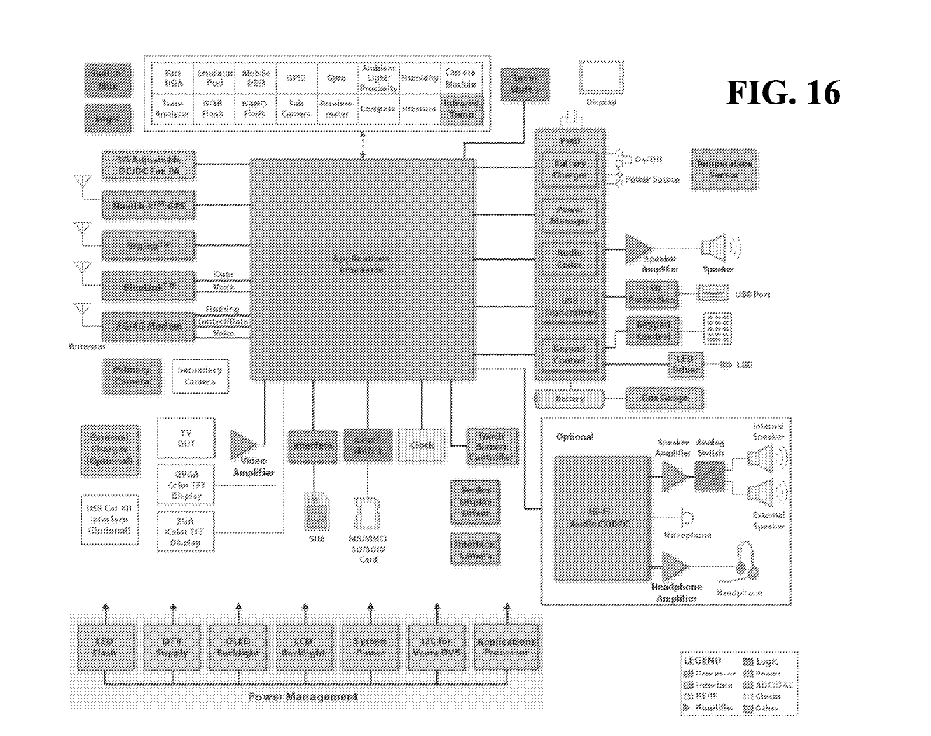

In FIG. 16, a detailed block diagram is shown of a conventional smartphone. The block diagram is published by Texas instruments at:
http://www.ti.com/solution/handset_smartphone#

The operation of personal communications devices 2 requires execution of code in the one or more processors such as the SP processor 3-1, the SD processor 15-1 of FIG. 12 or the PCD processor 3-1 of FIG. 14. The selection of which one or ones of the processors to employ for execution code is a matter of design choice. The following are examples of the functions to be carried out by execution of code in the personal communications devices 2 represented by the FIG. 12 embodiment.

Low Signal Code. Under normal high signal strength operation, the personal communications device 2 is operating in local cellular communications mode and the satellite communications is silent. When the received signal strength indicator (RSSI) in the smartphone 2 indicates that the cellular network communication strength is below a threshold, it suggests that sending or receiving a message via the local cellular network is not likely to get through. This low level signal strength indication is detected and initiates the Low Signal Code Algorithm (LSA).

In most cases, the LSA will immediately begin the satellite communications process. This process entails a) putting the local cellular communicator in the smartphone 22 in airplane mode, turning OFF the cellular radio in the smartphone 22; b) waking up the L band transverterin the satellite RF unit 7 of the satellite device 23; c) begin executing the transaction processing code for the transaction processing algorithm (TPA) and d) update the user screen in the smartphone 22 providing the user with new options that come with the satellite communications application. Examples of options include Google SMS search, email indexing and Mayday callout.

The LSA does not begin the satellite process when the RSSI signal strength indicator is intermittently adequate. In such cases, test code using hysteresis of the RSSI signal strength indicator will evaluate the need to switch to satellite communications. As a result of the test, a decision to switch to satellite mode is made. Similarly, if the RSSI signal strength indicator test indicates that cellular communications can be performed while the communications is in satellite mode, a decision will be made whether to switch to cellular mode.

Low Energy Code. When the smartphone 22 has a low battery level, the energy monitoring code will initiate the Low Energy Algorithm. The energy monitoring code will check the RSSI indicator to evaluate the cellular communications signal strength. If the cellular communications signal strength is also low, a message is displayed on the display/touch screen 10-1 of smartphone 22 indicating that the smartphone 22 will be placed in Airplane Mode to conserve energy. This operation allows the smartphone 22 to retain adequate energy to complete a satellite message when needed.

Mayday Emergency Code. In order to respond to a significant emergency, a special input is provided to override and take priority over all other functions. The special input in one embodiment is a “Mayday Button” touch screen button displayed on the display/touch screen 10-1 of the smartphone 22. Alternatively, the satellite device 23 includes a physical button (not shown) that provides a “Mayday Signal” to activate the Mayday Code. Upon activation, the mayday code will execute the Mayday Processor Algorithm (MPA). In such case, the MPA will a) get a GPS fix on the location of the personal communications device 2, b) evaluate all communications paths to find out which communications paths are feasible; c) calculate satellite positions of appropriate satellites; d) evaluate the nature of the emergency, for example, by posing a small number of questions (four to five) to the user; e) select and then activate all appropriate transmitters and receivers.

Satellite Pointing Code. The satellite antennas 9 (see FIG. 4) of the personal communications devices 2 tend to be omnidirectional. However, by pointing the antenna in the satellite direction, sometimes a few dB of pointing gain can be achieved. This gain can make the difference between a successful satellite communication link and not. When communicating with satellites, a) the GPS location and the 3d orientation of the phone and b) the location of the satellite are known. This information allows the user to point the phone in the optimal direction toward the satellite for best communications gain. The satellite pointing code is executed using this information to perform the Satellite Pointing Algorithm (SPA). The SPA provides guidance in a user friendly way so that the user can reposition the orientation of the personal communications devices 2 as needed.

Occlusion Code. In general, when there is clear sky between the personal communications devices 2 and the satellite, the messages to the satellite will get through. However, when there is an object of size (and bulk) in between the personal communications devices 2 and the satellite, the signal may or may not get through. The sensing of an occlusion is achieved by an Occlusion Algorithm using images from the camera 10-2, the view angle as determined by the Satellite Pointing Algorithm and execution of pattern recognition software.

In some case, the Occlusion Algorithm will be able to recognize a problem and provide some suggestions to the user for repositioning. Often the suggestions are as simple as “move right” or “move left”. Sometimes the guidance to the user will be more complex.

Battery Management Code. Battery management code performs a Battery Management Algorithm (BMA) which keeps track of energy spent and energy available. The BMA determines the energy required to communicate by cellular and by satellite. The BMA determines the current charge state of the batteries, battery 4-2 in the smartphone 4-2 and battery 16-2 in the satellite device 16-2. The BMA also manages the charging of the capacitors FIG. 16-3 (when needed) and the recharging of all batteries and capacitors. An external plug 19 is provided to power the personal communications devices 2 in emergency conditions.

Transaction Processing Code. When satellite messages are sent or received, charges for this service are applied. The reimbursement for these charges will be by credit or debit card. However, in most cases, the transaction information will be stored on the personal communications devices 2 and maintained until the next time that the personal communications devices 2 is within cellular range. Typically, the transaction costs and other data are not sent over the satellite channel. When the personal communications devices 2 is within cellular range, the accumulated transactions and charges are dumped to a processing center such as Paypal or Square which will complete payments and processing for the transactions.

It is evident from the foregoing description that the personal communications device 2 has many uses and features which are further hereinafter described.

a) The personal communications device 2 has augmented reality for satellite antenna positioning to increase the gain and therefore better achieve acceptable communications. This augmented reality uses knowledge of the satellite location and personal communications device 2 location to visually or audibly point to the location of the desired satellite whereby the user can move the personal communications device 2 to a most favorable orientation.

b) The personal communications device 2 is conveniently locates a satellite device as a transverter in an exterior case that holds and connects to a smartphone thereby allowing the smartphone to use frequency transverter to communicate with satellites.

c) The personal communications device 2 allows the smartphone to use space-texting with data fields which send/receive text messages over a satellite.

d) The personal communications device 2 permits SOS broadcasts using multiple satellites (LEO and GEO) whereby such satellite diversity insures communications anywhere in the world.

e) The personal communications device 2 permits SOS/911 broadcasts with information on the nature of the emergency communicated and permits use of artificial intelligence to ask appropriate questions to determine the nature of the emergency.

f) The personal communications device 2 permits Satellite polling for incoming messages (“anybody calling me?”) polling technique to find out if anyone is calling.

g) The personal communications device 2 permits satellite SMS space texting to search engines to initiate search engine look-ups.

h) The personal communications device 2 permits watt-second power management.

i) The personal communications device 2 permits rural 911 emergency processing of satellite texting to enable faster 911 responses.

j) The personal communications device 2 permits satellite communications to find the nearest gas station or other facility.

k) The personal communications device 2 permits First Aid look-up and in some embodiments stores locally a first aid guide.

l) The personal communications device 2 permits hierarchical texting progression where cellular texting is attempted first and, if not successful, then satellite texting is tried..

m) The personal communications device 2 permits E-mail check-in to see what messages are on a user's server and send messages such as “I am on a mountain” or “do I have any emails?”

n) The personal communications device 2 permits a smartphone to have an external cover that also serves as a platform for a satellite antenna.

o) The personal communications device 2 permits payments by credit card for text messages for satellite or other communications.

p) The personal communications device 2 permits 911 text via a satellite to PSAP.

q) The personal communications device 2 permits storage of reserve energy, “one last jolt”, to be used in case of a significant emergency.

r) The personal communications device 2 permits “magic hands”, a look and feel tool for instructions on operating and using personal communications device 2.

s) The personal communications device 2 permits, during national and large scale emergencies, broadcast reception and response even when local and grid power is not available.

t) The personal communications device 2 permits snap back with embedded electronics.

u) The personal communications device 2 permits flex circuits which extends around a smartphone for interconnecting the satellite device.

v) The personal communications device 2 permits circuitry built into a car or other vehicle for Bluetooth or NFC communications with a smartphone.

w) The personal communications device 2 permits finding the location of a car or other property via communications between the personal communications device 2 and the satellite.

x) The personal communications device 2 permits operation to find the speed of a car (or to sound an alarm for excess speed).

y) The personal communications device 2 permits a GPS fence.

z) The personal communications device 2 permits location-based transit by exception-supply.

aa) The personal communications device 2 permits tracking of children and sounding child abduction alarms.

bb) The personal communications device 2 permits refined pointing angle to improve communications to a satellite.

cc) The personal communications device 2 permits pattern recognition to identify /refine pointing angle occlusions.

dd) The personal communications device 2 permits VHF voice to first responders.

ee) The personal communications device 2 permits segregated responder categories (for example, a first responder has priority over other communications).

ff) The personal communications device 2 permits selection of the number of symbols/second (3000, 1200, other) that are employed.

The personal communications device 2 services include telephony, text messaging, multimedia service, email, internet service, and many business applications. These services are provided even when there is no cellular coverage.

The personal communications device 2 sends a voice message to another party and in a vehicle, the personal communications device 2 digitizes a voice sentence (or three) and sends this voice message via satellite to any phone or email destination. A voice message sent to a person in a vehicle is delivered over the vehicle's car audio system. While the invention has been particularly shown and described with reference to preferred embodiments thereof it will be understood by those skilled in the art that various changes in form and details may be made therein without departing from the scope of the invention.

1. A portable communications device (PCD) for communications with two or more communications systems comprising,
a power unit for powering the portable communications device,
a user interface for interfacing with a user,
a plurality of communication channels for carrying communications by the communications device,
a cross router for controlling one or more of the communication channels to be active for carrying communications for the portable communications device,
a control unit for controlling the portable communications device using the active one or more active communication channels.

2. The device of claim 1 wherein the plurality of communication channels include a cellular communication channel and a satellite communication channel.

3. The device of claim 2 wherein the plurality of communication channels include a Wifi channel.

4. The device of claim 1 wherein the cross router includes,
a protocol unit for storing the protocol for each of the communication channels,
a channel state unit for detecting the availability of each of the communication channels for communications with the portable communications device,
a channel logic unit for analyzing the available ones of the communication channels and setting the active and inactive state of the communication channels,
a channel command unit for issuing commands for each of the active one or more communication channels according to the protocols in the protocol unit.

5. The device of claim 1 wherein the plurality of communication channels include one or more of a cellular communication channel, a satellite communication channel, a Wifi channel, a BlueTooth channel, a VoIP channel and a NFC channel.

6. A portable communications device (PCD) for communications with two or more communications systems comprising,
a power unit for powering the portable communications device,
a transceiver unit including,
a local unit for communicating with a local communications system,
a satellite unit for communicating with a satellite communications system,
a control unit for controlling communications by the local unit and the satellite unit, the control unit including,
a sensing algorithm for sensing requests for communications,
a selection algorithm for selecting the local unit and/or for selecting the satellite unit for communications,
a parameter algorithm for controlling communications for the device based upon parameters.

7. The device of claim 1 wherein the.
